(19) United States
(12) Patent Application Publication
(10) Pub. No.: US 2008/0184527 A1
(43) Pub. Date: Aug. 7, 2008

(54) Hinge structure having leaf portions with adjustable clamping force arm

(76) Inventor: Po-Tsun Chao, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/878,186

(22) Filed: Jul. 23, 2007

(30) Foreign Application Priority Data
Feb. 6, 2007 (TW) 96104236

(51) Int. Cl. E05D 7/00

(52) U.S. Cl. 16/221

(57) ABSTRACT

A hinge structure having leaf portions with adjustable clamping force arm includes a leaf structure and a pintle. The leaf structure includes a C-shaped barrel portion, and a first and a second leaf portion connected to and extended from two opposite axial edges of the barrel portion. Free ends of the first and second leaf portions are bound together by at least one leaf locating element. With the leaf locating element functioning as a fulcrum, a clamping force arm section is defined on each leaf portion between the fulcrum and the barrel portion. The pintle is rotatably received in the barrel portion with a predetermined rolling friction existed between them. The predetermined rolling friction is adjustable through mounting at least one adjusting element to the two clamping force arm sections.

### FIELD OF THE INVENTION

The present invention relates to a hinge structure, and more particularly to a hinge having leaf portions with adjustable clamping force. The hinge includes a C-shaped barrel portion and two leaf portions extended from two axial edges of the barrel portion. A pintle is rotatably received in the barrel portion. Free ends of the two leaf portions are tightened together with at least one leaf locating element, which functions as a fulcrum, so that a clamping force arm section is defined on each leaf portion between the fulcrum and the barrel portion to provide a predetermined rolling friction between the barrel portion and the pintle.

### BACKGROUND OF THE INVENTION

Hinges are quite often used in various electric and electronic apparatus to connect two members of the apparatus, so that the two members are pivotally turnable about the hinges relative to one another. For example, a notebook computer uses hinges to pivotally connect a liquid crystal display (LCD) screen to a computer case, so that a user may pivotally lift and close the LCD screen from and onto the computer case. There are still many other devices, such as mobile phones, personal digital assistants (PDAs), global positioning systems (GPSs), and many testing instruments, that use hinges thereon.

A conventional hinge mainly includes one or two leaves, each of which is formed at one lateral edge with a barrel, through which a pintle is extended. When the pintle is turned, an outer wall surface of the pintle is in frictional contact with an inner wall surface of the barrels, so as to provide a fixed moment of force required by the apparatus using the hinge. To enable the device using the hinge to always have constant friction moment when being lifted or closed, a forward barrel and a backward barrel are normally provided at one lateral edge of the leaf, so that the two barrels enclose the pintle in two opposite directions.

There are various types of hinges of prior art developed to meet different demands for hinges. For example, U.S. Pat. No. 6,671,929 discloses a hinge for a notebook computer composed of a pintle, a resilient sleeve, and two barrels. Each of the two barrels is formed at one side of a leaf, and the pintle is extended through the two barrels to thereby connect to the two leaves. U.S. Pat. No. 6,820,307 discloses an elastic hinge for a notebook computer compose of a pintle and two barrels. Each of the two barrels is formed at one side of a leaf, and the pintle is extended through the two barrels to thereby connect to the two leaves. U.S. Pat. No. 6,470,532 discloses a hinge for notebook computer including a band portion having a cylinder portion formed at one edge thereof, a lid portion having an opening formed thereon, and a hinge pin extended through the cylinder portion on the band portion and the opening on the lid portion. U.S. Pat. No. 6,711,782 discloses a duplex opposite friction hinge. U.S. Pat. No. 6,321,416 discloses a hinge for a notebook computer composed of a leaf having a C-shaped sleeve formed at an edge thereof and a pintle pivotally received in the C-shaped sleeve of the leaf.

There are some problems existed in the hinges of prior art. For example, most of the conventional hinge structures include at least one leaf, one side of which is curved almost by 360 degrees to form at least one barrel. It requires highly accurate technique and accordingly, highly precision machines to mechanically form the barrel. Once the barrel is formed, it is impossible to adjust a compression force applied by the barrel against the pintle. When the hinge has been used over a long time, the compression force applied by the barrel against the pintle would become reduced due to wearing off of material under frequent frictional contact of the barrel with the pintle.

There is also problem in the association of the pintle with the barrel. Since the formed barrel has a considerably high mechanical deformation resistance, the pintle is conventionally fitted in the barrel by aligning the pintle with the barrel and then driving the pintle into the barrel with a suitable tool. By doing this, a lot of time and labors are required while there is a high bad yield in assembling the pintle to the barrel. In case of any minor error in the assembling operation, both the pintle and the leaf are subjected to damage, and the inaccurately assembled hinge must be discarded.

### SUMMARY OF THE INVENTION

A primary object of the present invention is to provide a hinge structure that includes a C-shaped barrel portion for rotatably receiving a pintle therein, and two leaf portions extended from two axial edges of the barrel portion to provide two clamping force arms. The two leaf portions provide the barrel portion with adjustable elastic compression force, so that the pintle is received in the barrel portion with a predetermined rolling friction existed between them.

Another object of the present invention is to provide a hinge structure that could be easily assembled in the manufacturing process simply by tightening two leaf portions together to clamp a pintle in a barrel portion. The pintle and the leaf portions could then be separately locked to two members to be pivotally turned relative to each other.

A further object of the present invention is to provide a hinge structure including a leaf structure and a pintle that could be separately fabricated, and the pintle could be easily assembled to the leaf structure. Therefore, the hinge structure could be produced at high productivity and good yield.

To fulfill the above objects, the present invention provides a hinge structure having leaf portions, which includes a leaf structure and a pintle. The leaf structure includes a C-shaped barrel portion, and a first and a second leaf portion connected to and extended from two opposite axial edges of the barrel portion. Free ends of the first and second leaf portions are bound together by at least one leaf locating element. With the leaf locating element functioning as a fulcrum, a clamping force arm section is defined on each leaf portion between the fulcrum and the barrel portion. The pintle is rotatably received in the barrel portion with a predetermined rolling friction existed between them. The predetermined rolling friction is adjustable through mounting at least one adjusting element to the two clamping force arm sections.

In addition to the advantages of having simple structure and easy to assemble, the hinge structure of the present invention is further characterized by having two leaf portions with an adjustable clamping force arm each. When the hinge structure has been used over a long time, and the contact areas between the barrel portion and the pintle are worn off to reduce the predetermined rolling friction between the barrel portion and the pintle, at least one clamping force adjusting element may be mounted to the clamping force arms on the two leaf portions to adjust the clamping force provided by the leaf portions, and accordingly, the predetermined rolling friction between the barrel portion and the pintle, so that the wearing of the contact areas is self-compensated.

In the hinge structure of the present invention, since the pintle can be easily clamped in the barrel portion by tightening the two leaf portions, it is not necessary to forcefully drive the pintle into the barrel portion with a tool. As a result, the hinge structure could be assembled at high efficiency and low bad yield.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an exploded perspective view of a hinge having leaf portions with adjustable clamping force constructed according to a first embodiment of the present invention;

FIG. 2 is an assembled view of the hinge of FIG. 1;

FIG. 3 is a sectional view taken on line 3-3 of FIG. 2;

FIG. 4 is an exploded perspective view of a hinge constructed according to a second embodiment of the present invention;

FIG. 5 is an exploded perspective view of a hinge constructed according to a third embodiment of the present invention;

FIG. 6 is an assembled view of the hinge of FIG. 5; and

FIG. 7 is a sectional view taken on line 7-7 of FIG. 6.

### DETAILED DESCRIPTION OF THE PREFERRED EMBODIMENTS

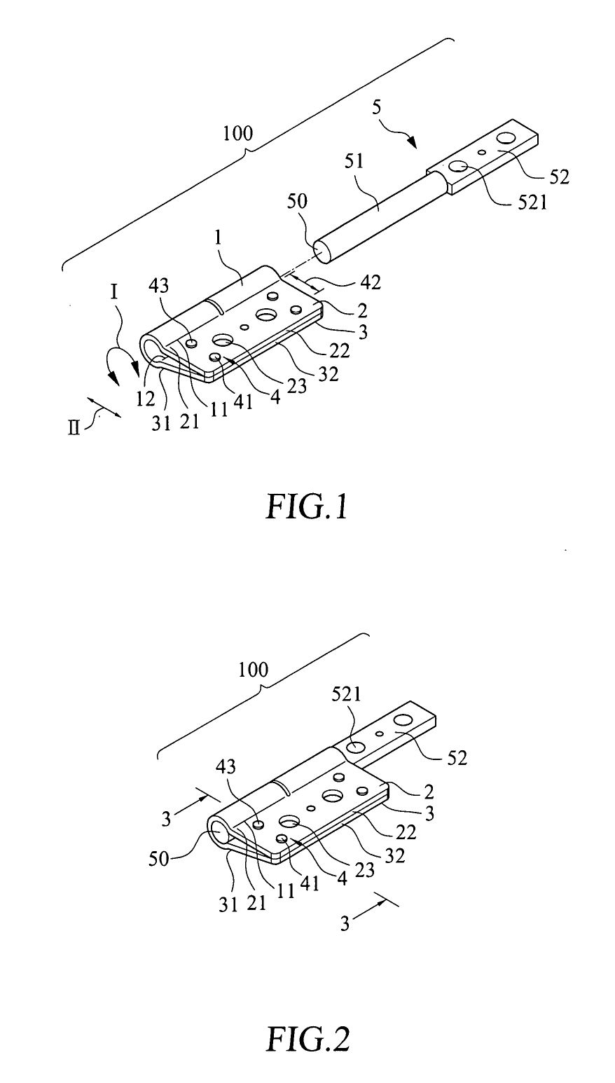

Please refer to FIGS. 1 and 2 that are exploded and assembled perspective views, respectively, of a hinge structure having leaf portions with adjustable clamping force arm according to a first embodiment of the present invention. As shown, the hinge structure in the first embodiment is generally denoted a reference numeral 100, and includes a barrel portion 1, a first leaf portion 2, a second leaf portion 3, and at least one leaf locating element 4.

The barrel portion 1 has a first edge 11 and a second edge 12 located opposite to the first edge 11. The barrel portion 1 is formed by extending from the first edge 11 in a circular direction I to the second edge 12, and accordingly, has a substantially C-shaped cross section.

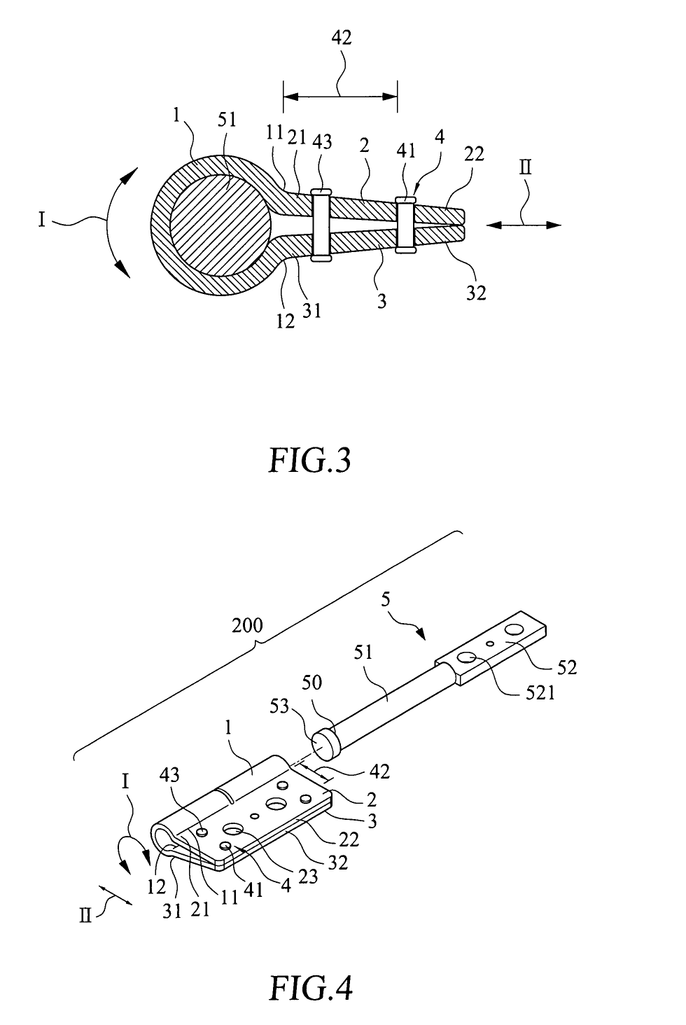

Please also refer to FIG. 3, which is a sectional view taken on line 3-3 of FIG. 2. The first leaf portion 2 has a root end 21 and a free end 22. The first leaf portion 2 is connected at the root end 21 to the first edge 11 of the barrel portion 1 with the free end 22 extended away from the first edge 11 of the barrel portion 1 in a direction defined by a horizontal datum plane II. Similarly, the second leaf portion 3 has a root end 31 and a free end 32. The second leaf portion 3 is connected at the root end 31 to the second edge 12 of the barrel portion 1 with the free end 32 extended away from the second edge 12 of the barrel portion 1 in a direction defined by the horizontal datum plane II. Therefore, the second leaf portion 3 is located opposite to the first leaf portion 2.

In manufacturing the hinge structure 100, the barrel portion 1, the first leaf portion 2, and the second leaf portion 3 could be fabricated and machined using general simple sheet metal processing techniques to complete a leaf structure in the form of a clamp.

The leaf locating element 4 is mounted to a position near the free ends 22, 32 of the first and the second leaf portion 2, 3, respectively, such that the free ends 22, 23 closely adjoin each other and are tightly bound together by the leaf locating element 4. The leaf locating element 4 also functions as a fulcrum 41, so that a clamping force arm section 42 is defined on each of the two leaf portions 2, 3 between the fulcrum 41 and the root end 21, 31.

The hinge structure 100 also includes a pintle 5 having a shaft 51 and an end plate 52. The pintle 5 is associated with the leaf structure with the shaft 51 rotatably received in the barrel portion 1. The clamping force arm sections 42 of the first and second leaf portions 2, 3 function for the barrel portion 1 to clamp around the shaft 51 with a predetermined rolling friction existed between them. As can be understood by those skilled in the art, the leaf locating element 4 may be a rivet, a bolt, and other known fastening elements. Alternatively, the first leaf portion 2 and the second leaf portion 3 may be welded together near the free ends 21, 32.

Preferably, it is further provided within the clamping force arm section 42 at least one adjusting bolt to serve as a clamping force adjusting element 43, so as to adjust the predetermined rolling friction between the barrel portion 1 and the shaft 51.

To assemble the hinge structure 100, firstly a free end 50 of the shaft 51 is aligned with the barrel portion 1 and then the shaft 51 is inserted into the barrel portion 1. At this point, the free end 22 of the first leaf portion 2 is closely adjacent to but not tightly bound to the free end 32 of the second leaf portion 3. Thereafter, the two free ends 22, 32 are tightened together with the at least one leaf locating element 4 to provide a fulcrum 41 at the leaf locating element 4. The hinge structure 100 is now ready for use. The clamping force arm sections 42 enable the barrel portion 1 to rotatably receive the shaft 51 therein with a predetermined rolling friction existed between them. When necessary, the clamping force adjusting element 43 may be mounted to the clamping force arm sections 42 to adjust the predetermined rolling friction.

The first leaf portion 2 and the second leaf portion 3 are correspondingly provided with at least one fastening hole 23, via which a known fastening element (not shown) may be extended to lock the bound first and second leaf portions 2, 3 to, for example, a computer case of a notebook computer.

The end plate 52 of the pintle 5 is connected to an mounting end of the shaft 51 opposite to the free end 50, and is provided with at least one mounting hole 521, via which a known fastening element (not shown) may be extended to lock the pintle 5 to, for example, an LCD of a notebook computer.

FIG. 4 is an exploded perspective view of a hinge structure 200 according to a second embodiment of the present invention. Since the hinge structure 200 in the second embodiment is generally structurally similar to the hinge structure 100 in the first embodiment, components that are the same or similar in the two embodiments are denoted by the same reference numerals. The hinge structure 200 is different from the hinge structure 100 in that the shaft 51 of the pintle 5 in the second embodiment has an expanded head portion 53 formed at the free end thereof. The barrel portion 1 is fitted around the shaft 51 to locate between the expanded head portion 53 and the end plate 52, preventing the pintle 5 from axially separating from the barrel portion.

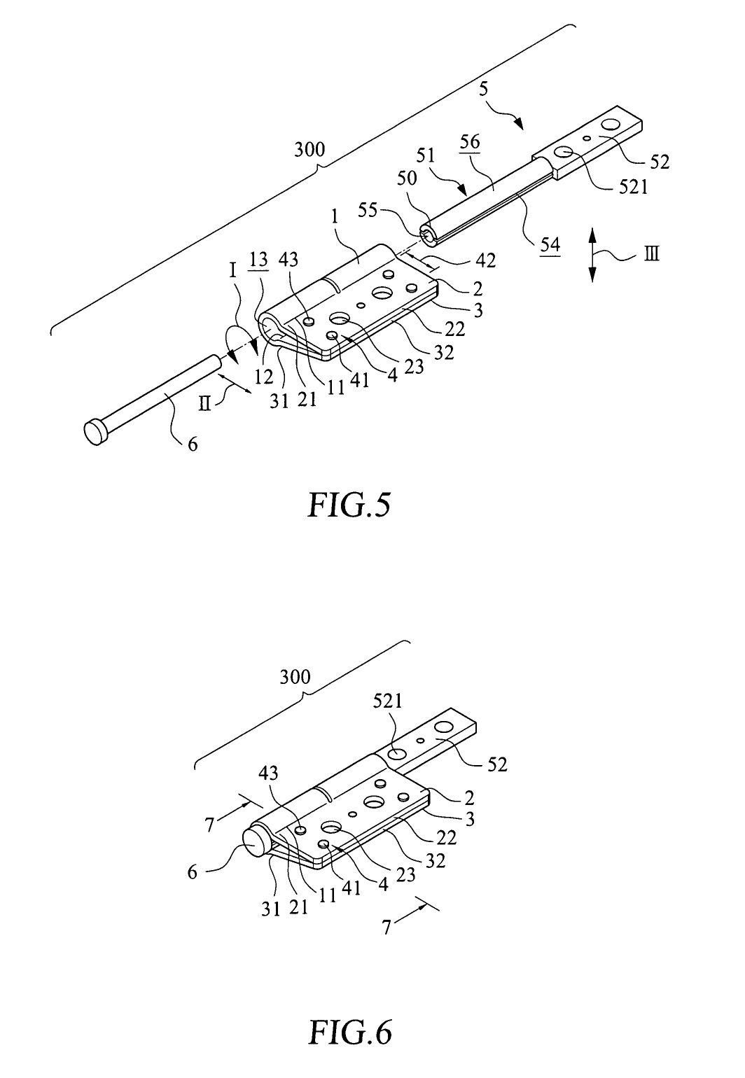

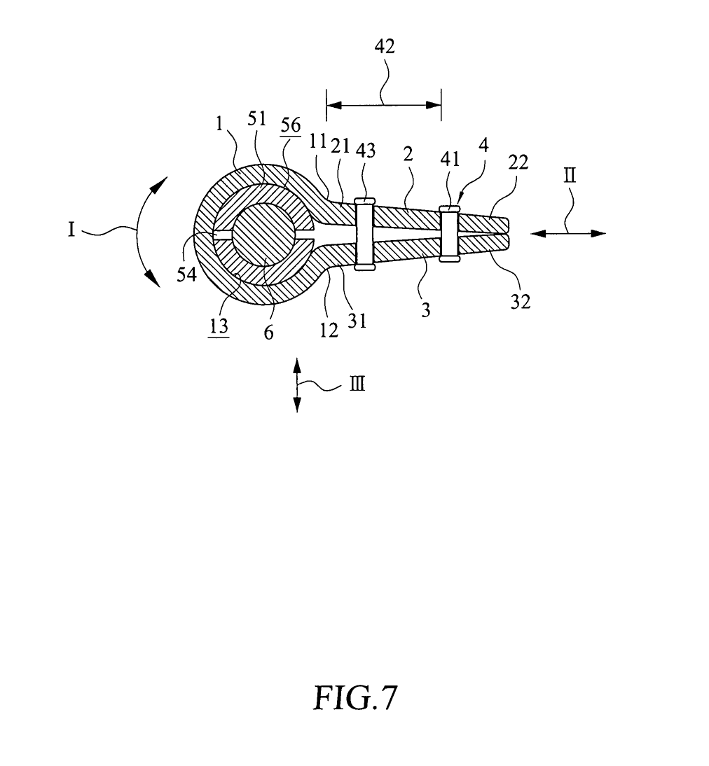

FIGS. 5 and 6 are exploded and assembled perspective views, respectively, of a hinge structure 300 according to a third embodiment of the present invention; and FIG. 7 is a sectional view taken on line 7-7 of FIG. 6. Since the hinge structure 300 in the third embodiment is generally structurally similar to the hinge structure 100 in the first embodiment, components that are the same or similar in the two embodiments are denoted by the same reference numerals. The hinge structure 300 is different from the hinge structure 100 in that the shaft 51 in the third embodiment is provided with an axially extended slit 54, which extends from the free end 50 of the shaft 51 toward the end plate 52, so that the shaft 51 has some degree of elasticity and could be radially expanded or compressed along a direction III. Moreover, the shaft 51 also defines a central bore 55 communicating with the slit 54.

To assemble the hinge structure 300, firstly the free end 50 of the shaft 51 is aligned with the barrel portion 1 and then the shaft 51 is inserted into the barrel portion 1. Then, an insertion pin 6 is inserted into the central bore 55 of the shaft 51 via the free end 50 thereof, so that the shaft 51 is radially expanded along a direction III to have an increased diameter. This would bring an outer wall surface 56 of the shaft 51 to contact with an inner wall surface 13 of the barrel portion 1 with a predetermined rolling friction existed between them. Thereafter, the two free ends 22, 32 together are tightened with the at least one leaf locating element 4 to provide a fulcrum 41 at the leaf locating element 4. The hinge structure 300 is now ready for use.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A hinge structure adapted to couple a shaft of a pintle, comprising:
a barrel portion having a first edge and a second edge opposite to the first edge, and the barrel portion being formed by extending from the first edge in a circular direction to the second edge, and accordingly, having a substantially C-shaped cross section;
a first leaf portion having a first root end and a first free end; the first leaf portion being connected at the first root end to the first edge of the barrel portion with the first free end extended away from the first edge of the barrel portion in a direction defined by a horizontal datum plane;
a second leaf portion having a second root end and a second free end; the second leaf portion being connected at the second root end to the second edge of the barrel portion with the second free end extended away from the second edge of the barrel portion in a direction defined by the horizontal datum plane; and
at least one leaf locating element mounted to a position near the first free end of the first leaf portion and the second free end of the second leaf portion, so that the first and the second free end are closely adjacent to and tightly bound to each other by the at least one leaf locating element; and the leaf locating element also functioning as a fulcrum, so that a clamping force arm section is defined between the fulcrum and the first root of the first leaf portion, and between the fulcrum and the second root of the second leaf portion; and
wherein the shaft of the pintle is rotatably received in the barrel portion and subjected to a compression from the clamping force arm sections of the first and the second leaf portion, such that a predetermined rolling friction is existed between the shaft and the barrel portion.

2. The hinge structure as claimed in claim 1, further comprising at least one clamping force adjusting element mounted to the clamping force arm sections on the first and the second leaf portion for adjusting the predetermined rolling friction between the shaft of the pintle and the barrel portion.

3. The hinge structure as claimed in claim 1, wherein the pintle further comprises a end plate connected to a first end of the shaft, and a second end of the shaft opposite to the first end is a free end formed into an expanded head portion; and wherein the barrel portion receiving the shaft is located between the expanded head portion and the end plate.

4. The hinge structure as claimed in claim 1, wherein the shaft of the pintle is provided with an axially extended slit and an axial central bore communicating with the slit; whereby when the shaft of the pintle has been received in the barrel portion, an insertion pin is inserted into the central bore of the shaft, causing the shaft with the axial slit to be radially expanded to have an increased diameter, so that a predetermined rolling friction is existed between an outer wall surface of the shaft and an inner wall surface of the barrel portion.

5. The hinge structure as claimed in claim 1, wherein the leaf locating element comprises at least one rivet.

6. The hinge structure as claimed in claim 1, wherein the leaf locating element comprises at least one bolt.
